(19) United States
(12) Patent Application Publication
(10) Pub. No.: US 2024/0410340 A1
(43) Pub. Date: Dec. 12, 2024

(54) LIGHTNING PROTECTION SYSTEM

(71) Applicant: Vestas Wind Systems A/S, Aarhus N. (DK)

(72) Inventors: Nathan A. Brilliant, Arvada (DK); Toby Collard, Cowes, Isle of Wight (GB); Mohamed Hashim Ariyur, Newport (GB); Karl Gregory, Cowes (GB)

(73) Assignee: Vestas Wind Systems A/S, Aarhus N. (DK)

(21) Appl. No.: 18/717,503

(22) PCT Filed: Dec. 8, 2022
(86) PCT No.: PCT/DK2022/050271

§ 371 Date: Jun. 7, 2024

Related U.S. Application Data
(60) Provisional application No. 63/288,095, filed on Dec. 10, 2021.

(30) Foreign Application Priority Data
Jan. 11, 2022 (DK) PA202270011

(51) Int. Cl. F03D 80/30; F03D 1/06

(52) U.S. Cl. CPC F03D 80/301; F03D 1/0675; F05B 2280/1021; F05B 2280/105

(57) ABSTRACT

A wind turbine blade having a blade shell with a lightning protection system. The lightning protection system has a first metal layer at an outer surface of the blade shell and a second metal layer at the outer surface of the blade shell and stacked on the first metal layer to form intimate electrical contact with the first metal layer at a multiple-thickness region.

### FIELD OF THE INVENTION

The present invention relates to a wind turbine blade having a blade shell with a lightning protection system, a plurality of wind turbine blades, and methods of manufacturing a wind turbine blade.

### BACKGROUND OF THE INVENTION

Wind turbines are susceptible to lightning strikes, and the blades of wind turbines are particularly susceptible to lightning strikes.

As a result, it is common for a wind turbine blade to include a lighting protection system that electrically couples the wind turbine blade to ground. This lightning protection system may include lightning receptors and conductors that are electrically connected from the blade, through the tower and nacelle, to ground. The lightning protection system may also include a surface protection layer (SPL), for instance a metal mesh or foil surface protection layer, incorporated into the blade shell at the outer surface of the blade and extending along at least a portion of the blade. This surface protection layer typically covers a significant portion of the blade surface and intercepts lightning strikes from reaching conductive components of the blade. The surface protection layer is susceptible to damage in the event of a lightning strike and may require repair.

### SUMMARY OF THE INVENTION

A first aspect of the invention provides a wind turbine blade having a blade shell with a lightning protection system; the lightning protection system comprising: a first metal layer at an outer surface of the blade shell; and a second metal layer at the outer surface of the blade shell and stacked on the first metal layer to form intimate electrical contact with the first metal layer at a multiple-thickness region.

The invention is advantageous in that the metal layers of the lightning protection system at the multiple-thickness region provide more robust protection against lightning strikes as compared with a single metal layer of equivalent conductivity to one of the first or second metal layers alone. Using multiple metal layers has advantages compared with using a single, thicker metal layer. The multiple-thickness region is more than mere edge overlap between discrete sections of a single metal layer to ensure electrical conductivity across the single layer.

A second aspect of the invention provides a wind turbine blade having a blade shell with a lightning protection system; the lightning protection system comprising: a first metal layer at an outer surface of the blade shell; and a second metal layer at the outer surface of the blade shell and stacked on the first metal layer to form intimate electrical contact with the first metal layer at a multiple-thickness region; and an electrical component, wherein the first and second metal layers are electrically connected to the electrical component by an electrically conductive pin that extends through the multiple-thickness region.

According to this aspect of the invention the electrical connection between the pin and the lightning protection system is made at the multi-thickness region of the metal layers, where the pin is electrically connected to both the first and second metal layers.

A further aspect of the invention provides a plurality of wind turbine blades according to the first or second aspects, wherein the plurality of wind turbine blades have a substantially identical shape and size, and wherein an arrangement of the first and second metal layers of one of the plurality of wind turbine blades is designed to be different to an arrangement of the first and second metal layers of another one of the plurality of wind turbine blades.

According to this aspect of the invention, changes in the arrangement of the metal layers can be made to match the lightning protection system of different blades to different requirements, e.g. regulatory, turbine site location, etc. with minimal changes to the blade design and manufacture. For example, the different arrangement of the first and second metal layers may be the extent of the multiple-thickness region. In an example, a first of the plurality of blades may have a multiple-thickness regions which covers the majority of the shell of the blade, whereas as second of the plurality of blades may have a multiple-thickness regions which is only at the tip of the blade.

A further aspect of the invention provides a method of manufacturing a wind turbine blade having a blade shell, comprising: laying a first metal layer of a lightning protection system of the blade shell into a blade mould; laying a second metal layer of the lightning protection system into the blade mould so that the second metal layer is stacked on the first metal layer to form a multiple-thickness region having a width of at least 200 mm and a length of at least 200 mm.

A further aspect of the invention provides a method of manufacturing a wind turbine blade having a blade shell, comprising: laying a first metal layer of a lightning protection system of the blade shell into a blade mould; laying a second metal layer of the lightning protection system into the blade mould so that the second metal layer is stacked on the first metal layer to form a multiple-thickness region; and extending an electrically conductive pin through the multiple-thickness region to electrically connect the first and second metal layers to an electrical component of the lightning protection system.

Optionally, the multiple-thickness region has a width of at least 200 mm and a length of at least 200 mm.

Optionally, the multiple-thickness region has a width of at least 500 mm and a length of at least 500 mm and preferably a width of at least 1 m and a length of at least 1 m.

Optionally, the multiple-thickness region extends across at least 50% of a surface area of the second metal layer, preferably at least 70%, and more preferably at least 90%.

Optionally, the electrical component is a down conductor of the lightning protection system.

Optionally, the first metal layer and the second metal layer are formed of the same material and/or have the same thickness.

Optionally, the first metal layer and the second metal layer are formed of different materials, preferably wherein one of the first and second metal layers is formed of aluminium and the other of the first and second metal layers is formed of copper.

Optionally, the first metal layer comprises a plurality of first metal layer portions with overlapping edges and/or the second metal layer comprises a plurality of second metal layer portions with overlapping edges.

Optionally, the overlapping edges have an overlap width of less than 200 mm.

Optionally, the overlapping edges of the first or second metal layer are offset from any overlapping edges of the other of the first and second metal layer.

Optionally, the first and second metal layers are joined by a metal disc that extends through the first and second metal layers, wherein the metal disc is for connection to an electrical component of the lightning protection system.

Optionally, the method of manufacturing a wind turbine blade further comprises: laying fibre layers of the blade shell in the blade mould; consolidating the fibre layers and the first and second metal layers in the blade mould to form intimate electrical contact between the first and second metal layers, prior to integration of the blade shell with a resin.

Optionally, the method of manufacturing a wind turbine blade further comprises: prior to laying the first and second metal layers in the blade mould: providing one or more metal disc constituents; and heating the one or more metal disc constituents to form a metal disc that extends through the first and second metal layers.

### BRIEF DESCRIPTION OF THE DRAWINGS

Embodiments of the invention will now be described with reference to the accompanying drawings, in which:

FIG. 1 shows a wind turbine;

FIG. 2 shows a wind turbine blade;

FIG. 3 shows a lightning protection system of the wind turbine blade;

FIG. 4 shows a surface protection layer of the lightning protection system;

FIG. 5 shows a chordwise section of a blade shell of the wind turbine blade;

FIG. 6 shows a spanwise section of the surface protection layer;

FIG. 7A shows a first metal layer of the surface protection layer in a blade mould;

FIG. 7B shows a second metal layer of the surface protection layer in the blade mould;

FIG. 7C shows a series of fibre layers laid on the first and second metal layers in the mould;

FIG. 7D shows a bagging film laid over the mould;

FIG. 8A shows a surface protection layer according to a second example;

FIG. 8B shows a spanwise section of the surface protection layer of FIG. 8A;

FIG. 9A shows an overlapping edge between first metal layers of a surface protection layer according to a third example;

FIG. 9B shows a second metal layer on the surface protection layer of the third example;

FIG. 10A shows electrically conductive pins extending through a surface protection layer according to a fourth example;

FIG. 10B shows a second metal layer on the surface protection layer of the fourth example;

FIG. 11A shows a pair of metal disc portions laid either side of the surface protection layer;

FIG. 11B shows a metal disc extending through the surface protection layer;

FIG. 11C shows a hole formed through the surface protection layer;

FIG. 11D shows an electrically conductive pin extending through the hole;

FIG. 11E shows the electrically conductive pin connected to the lightning protection system.

### DETAILED DESCRIPTION OF EMBODIMENT(S)

In this specification, terms such as leading edge, trailing edge, pressure surface, suction surface, thickness, chord and planform are used. While these terms are well known and understood to a person skilled in the art, definitions are given below for the avoidance of doubt.

The term leading edge is used to refer to an edge of the blade which will be at the front of the blade as the blade rotates in the normal rotation direction of the wind turbine rotor.

The term trailing edge is used to refer to an edge of a wind turbine blade which will be at the back of the blade as the blade rotates in the normal rotation direction of the wind turbine rotor.

The chord of a blade is the straight line distance from the leading edge to the trailing edge in a given cross section perpendicular to the blade spanwise direction. The term chordwise is used to refer to a direction from the leading edge to the trailing edge, or vice versa.

A pressure surface (or windward surface) of a wind turbine blade is a surface between the leading edge and the trailing edge, which, when the blade is in use, has a higher pressure than a suction surface of the blade.

A suction surface (or leeward surface) of a wind turbine blade is a surface between the leading edge and the trailing edge, which will have a lower pressure acting upon it than that of a pressure surface, when the blade is in use.

The thickness of a wind turbine blade is measured perpendicularly to the chord of the blade and is the greatest distance between the pressure surface and the suction surface in a given cross section perpendicular to the blade spanwise direction.

The term spanwise is used to refer to a direction from a root end of a wind turbine blade to a tip end of the blade, or vice versa. When a wind turbine blade is mounted on a wind turbine hub, the spanwise and radial directions will be substantially the same.

A view which is perpendicular to both of the spanwise and chordwise directions is known as a planform view. This view looks along the thickness dimension of the blade.

The term spar cap is used to refer to a longitudinal, generally spanwise extending, reinforcing member of the blade. The spar cap may be embedded in the blade shell, or may be attached to the blade shell. The spar caps of the windward and leeward sides of the blade may be joined by one or more shear webs extending through the interior hollow space of the blade. The blade may have more than one spar cap on each of the windward and leeward sides of the blade. The spar cap may form part of a longitudinal reinforcing spar or support member of the blade. In particular, the first and second spar caps may form part of the load bearing structure extending in the longitudinal direction that carries the flap-wise bending loads of the blade.

The term shear web is used to refer to a longitudinal, generally spanwise extending, reinforcing member of the blade that can transfer load from one of the windward and leeward sides of the blade to the other of the windward and leeward sides of the blade.

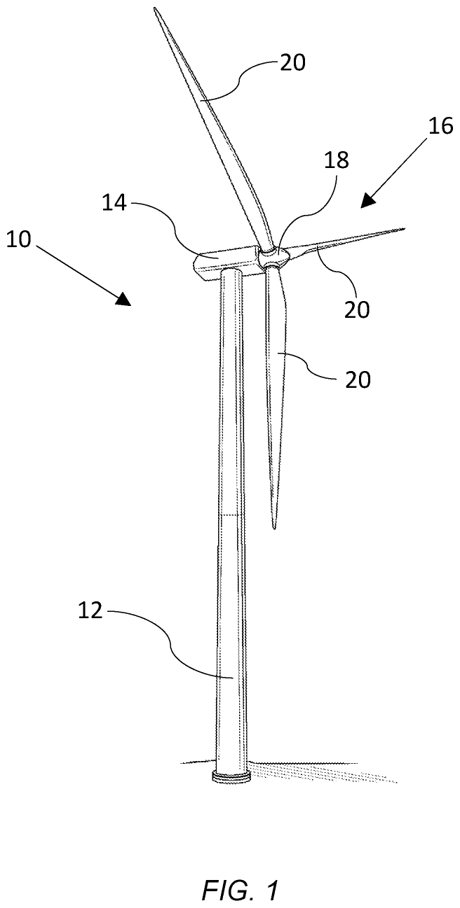

FIG. 1 shows a wind turbine 10 including a tower 12 mounted on a foundation and a nacelle 14 disposed at the apex of the tower 12. The wind turbine 10 depicted here is an onshore wind turbine such that the foundation is embedded in the ground, but the wind turbine 10 may be an offshore installation in which case the foundation would be provided by a suitable marine platform.

A rotor 16 is operatively coupled to a generator (potentially via a gearbox) (not shown) housed inside the nacelle 14. The rotor 16 includes a central hub 18 and a plurality of rotor blades 20, which project outwardly from the central hub 18. It will be noted that the wind turbine 10 is the common type of horizontal axis wind turbine (HAWT) such that the rotor 16 is mounted at the nacelle 12 to rotate about a substantially horizontal axis defined at the centre at the hub 18. While the example shown in FIG. 1 has three blades, it will be realised by the skilled person that other numbers of blades are possible.

When wind blows against the wind turbine 10, the blades 20 generate a lift force which causes the rotor 16 to rotate, which in turn causes the generator within the nacelle 14 to generate electrical energy.

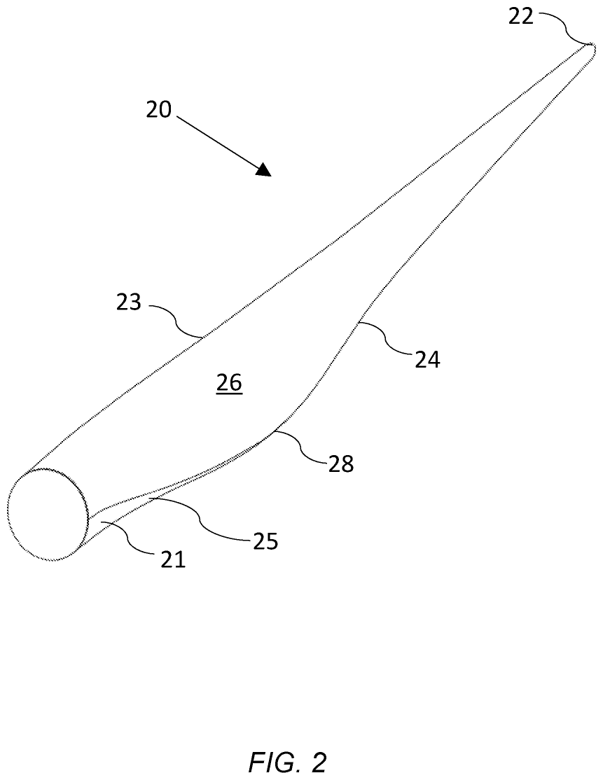

FIG. 2 shows an example of one of the wind turbine blades 20 for use in such a wind turbine. The blade 20 has a root end 21 proximal to the hub 18 and a tip end 22 distal from the hub 18. The blade 20 includes a leading edge 23 and a trailing edge 24 that extend between the root end 21 and tip end 22. The blade 20 includes a suction surface 25 and a pressure surface 26. A thickness dimension of the blade extends between the suction surface 25 and the pressure surface 26.

The blade 20 has a cross section that is substantially circular near the root end 21, as the blade portion near the root must have sufficient structural strength to support the blade portion outboard of that section and to transfer loads into the hub 18. The blade 20 may transition from a circular profile to an aerofoil profile moving from the root end 21 of the blade towards a “shoulder” 28 of the blade, which is the widest part of the blade 20 where the blade 20 has its maximum chord. The blade 20 has an aerofoil profile of progressively decreasing thickness in an outboard portion of the blade, which extends from the shoulder 28 to the tip end 22.

The wind turbine blade 20 may include an outer blade shell defining a hollow interior space with a shear web extending internally between upper and lower parts of the blade shell.

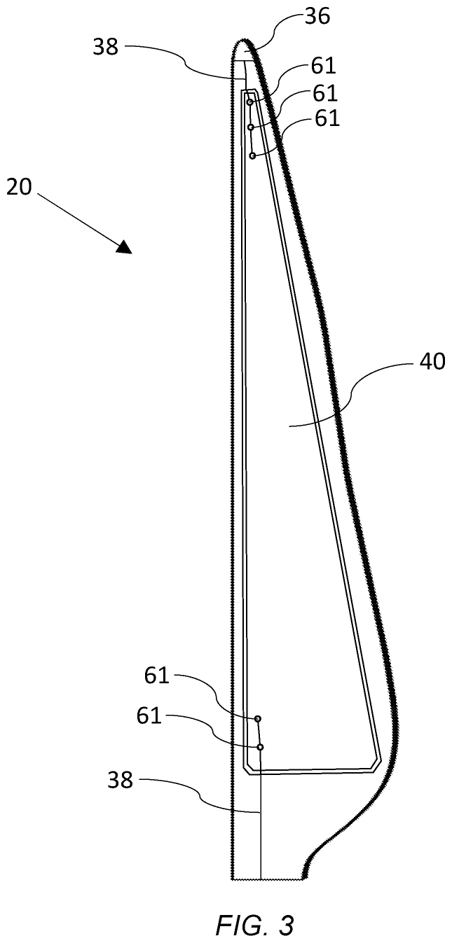

As shown schematically in FIG. 3, the blade 20 may include one or more lightning receptors 36 and one or more lightning down conductor cables 38 which form part of a lightning protection system for the wind turbine. The lightning receptors attract the lightning strike and the down conductor cables 38, which run through the hollow interior of the blade, conduct the energy of the lightning strike down the blade 20 via the nacelle 14 and tower 12 to a ground potential. In addition, the lightning protection system may include a surface protection layer 40 at the outer surface of the blade. The surface protection layer 40 may be electrically connected at each end to the down conductor cables 38.

The majority of the outer surface of the blade 20 may be covered with the surface protection layer 40, or only a portion of the outer surface of the blade 20 may be covered with the surface protection layer 40. The surface protection layer 40 serves to shield conductive material in the blade from a lightning strike, and may act as either a lightning receptor, a down conductor, or both. The down conductor may extend substantially the full length of the blade. In some examples, such as where the majority of the outer surface of the blade 20 is covered with the surface protection layer 40, the down conductor cable 38 may connect to the surface protection layer 40 adjacent the tip end 22 of the blade and adjacent the root end 21 of the blade, with no down conductor cable 38 along the majority of the length of the blade covered with the surface protection layer 40. The surface protection layer 40 may extend from root to tip in which case there may be no need for a down conductor cable 38. The surface protection layer 40 may extend in sections along the length of the blade with down conductor cable sections between the surface protection layer 40 sections. Down conductor cable 38 may alternatively extend under the surface protection layer 40 (inside the blade) so that the down conductor cable 38 and surface protection layer 40 are electrically connected in parallel.

At the root end 21 of the blade 20, the down conductor cable 38 may be electrically connected via an armature arrangement to a charge transfer route via the nacelle 14 or hub 18 and tower 12 to a ground potential. Such a lightning protection system therefore allows lightning to be channelled from the blade to a ground potential safely, thereby minimising the risk of damage to the wind turbine 10.

The down conductor cable 38 and surface protection layer 40 may be connected by one of more connectors or receptors. The connectors may comprise an electrically conductive pin 61 that extends through the surface protection layer 40 and connects to the down conductor cable 38. FIG. 3 shows five electrically conductive pins 61 connecting the down conductor cable 38 and the surface protection layer 40, although it will be understood that any number of electrically conductive pin 61 may be used, including one.

The surface protection layer 40 may extend up to the leading edge 23 of the wind turbine blade 20 and/or extend up to the trailing edge 24 of the wind turbine blade 20. Alternatively, the surface protection layer 40 may be spaced from the leading and/or trailing edge of the blade 20.

At least a portion of the surface protection layer 40 is formed of multiple electrically conductive metal layers 41, 42 stacked upon one another in the thickness direction.

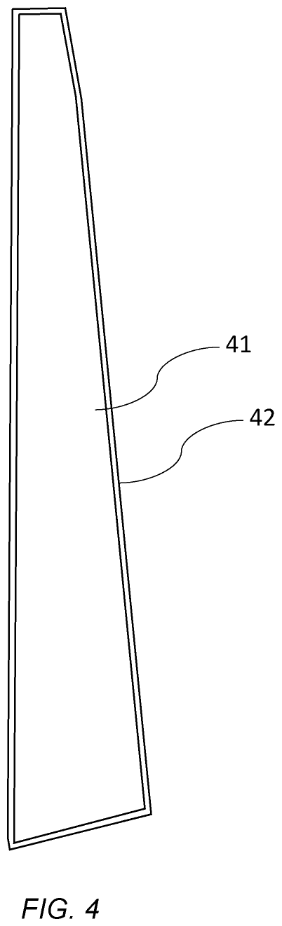

FIG. 4 shows the surface protection layer 40 comprising a first metal layer 41 and a second metal layer 42. Whilst FIG. 4 shows the first metal layer 41 spaced from the perimeter of the second metal layer 42, it will be understood that this is merely illustrative and that the first metal layer 41 may also extend up to the perimeter of the second metal layer 42 or extend beyond the perimeter of the second metal layer 42 at various points across the first metal layer 41.

The first and second metal layers 41, 42 are positioned at an outer surface of the blade shell and stacked on each other so as to form a multiple-thickness region of the surface protection layer 40 where intimate electrical contact between the first metal layer 41 and second metal layer 42 is formed. The multiple-thickness region has a width of at least 200 mm and a length of at least 200 mm.

The metal layers of the lightning protection system at the multiple-thickness region provide more robust protection against lightning strikes as compared with a single metal layer of equivalent conductivity to one of the first or second metal layers alone.

Whilst similar electrical conductivity may be achieved using a thicker single metal layer, e.g. of equivalent thickness to the total thickness of the first and second metal layers, using a single thick metal layer has been found to have a number of disadvantages. For example, introducing a thicker metal layer adds to the inventory of parts required for manufacturing a range of wind turbine blades (i.e. a new, thicker, metal layer is required), whereas using two layers of the same metal layer thickness as previously used has no impact on parts count. Furthermore, a thicker metal layer would have poorer handling qualities with decreased formability and drapability compared with using the same metal layer as previously used. These factors become more pronounced where it is desirable to have both single layer and multiple-thickness regions of the surface protection layer on the same blade. In such a circumstance the use of a thicker metal layer for only some regions of the blade becomes cumbersome, whereas using single and multiple layers of the same material is much easier to accommodate into the manufacture of the blade.

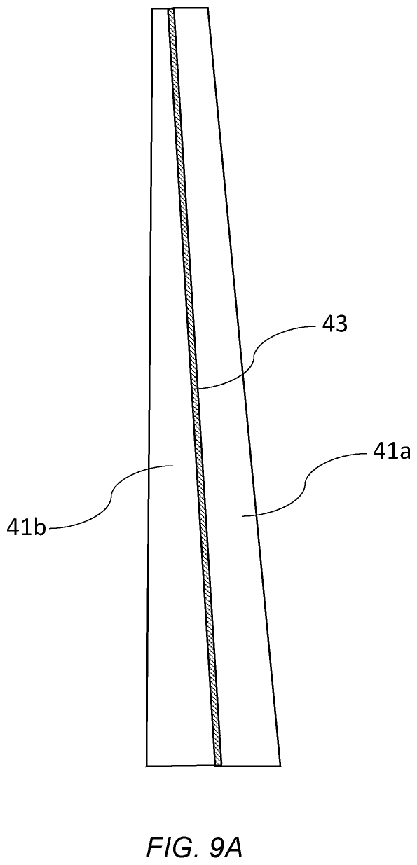

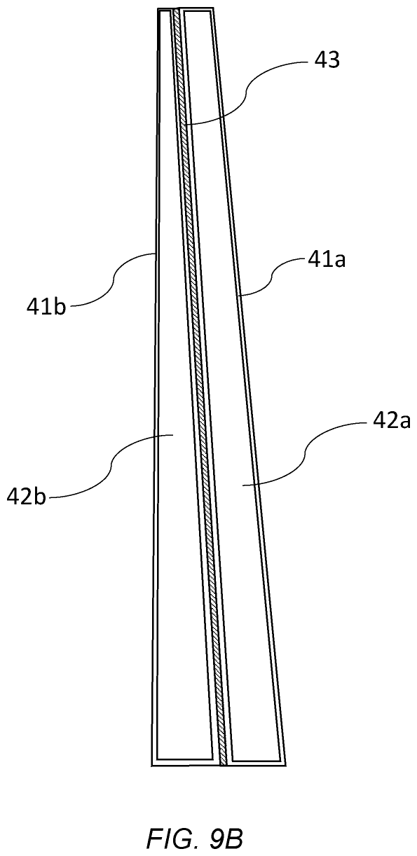

It should be noted that the first metal layer 41 may comprise a plurality of first metal layer portions 41a, 41b with overlapping edges 43 (See FIGS. 9A and 9B). Similarly, the second metal layer 42 may comprise a plurality of second metal layer portions 42a, 42b with overlapping edges 43. The material used for the metal layers 41, 42 may be provided as a roll of sheet material and therefore have a fixed width. This width will typically be less than the chordwise (or spanwise) extent of the blade and so multiple laterally adjacent portions from the roll of sheet material are required to cover the desired chordwise (or spanwise) extent of the blade to form each metal layer 41, 42. The laterally adjacent metal layer portions 41a, 41b, 42a, 42b have overlapping edges 43 to provide the required electrical connection across each metal layer 41 or 42. However it will be understood that these overlapping edges 43 are incidental features of forming the first and/or second metal layer 41, 42 to the desired size and therefore the size of the overlapping edges 43 is typically minimised. As a result, the overlapping edges 43 may have an overlap width of less than 200 mm, typically less than 100 mm.

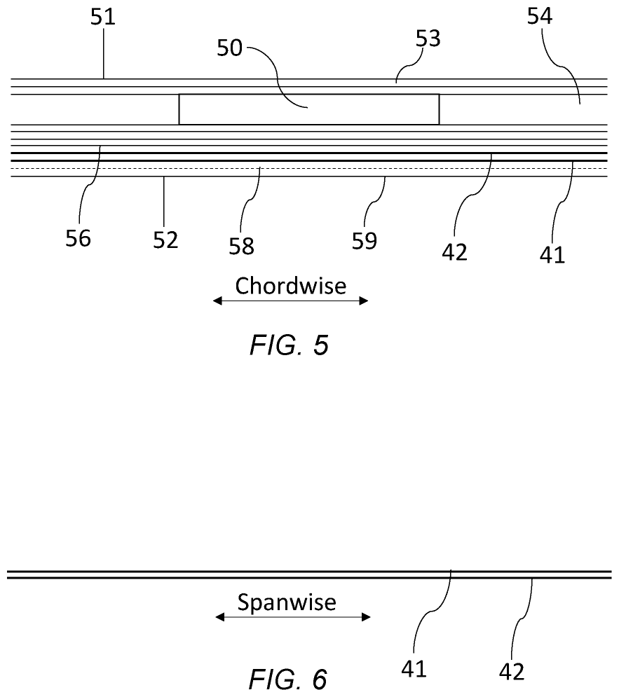

FIG. 5 shows a chordwise cross-section of the blade shell adjacent a suction surface of the wind turbine blade 20, viewed along a spanwise direction of the blade 20, although it will be clear that the features of the blade shell adjacent the pressure surface of the wind turbine blade 20 may be substantially the same.

The blade 20 includes a spar cap 50 where the shear web (not shown) meets the blade shell. The spar cap 50 is incorporated into the blade shell. In alternative arrangements the spar cap 50 may be connected to the inside of the blade shell. The spar cap 50 is an elongate reinforcing structure extending substantially along the full length of the blade 20 from the root end 21 to the tip end 22.

A core 54, such as a foam, balsa, or honeycomb core, may be positioned either side of the spar cap 50. One or more fibre layers 53 may be provided on an inner side of the spar cap 50, for example glass fibre layers or carbon fibre layers, which form the inner surface 51 of the blade 20. The fibre layers may be infused with resin to form a composite or may be pre-preg composite layers. Similarly, one or more layers 56 may be provided on an outer side of the spar cap 50. Where the spar cap is connected to the inside of the blade shell, the core 54 may fill between the one or more fibre layers which form the inner surface 51 and the one or more fibre layers 56.

The spar cap 50 may include conductive material, such as carbon fibres. For example, the spar cap may include pultruded fibrous strips of material such as pultruded carbon fibre composite material or other carbon fibre reinforced plastic material.

The spar cap 50 may be equipotentially bonded to the surface protection layer 40 to ensure that there is no build-up of charge in the spar cap, or a large voltage difference between the surface protection layer 40 and the spar cap 50 in the event of a lightning strike. The equipotential bonding also prevents arcing between the surface protection layer 40 and the spar cap 50 which may damage the blade. As shown in FIG. 5, the first and second metal layers 41, 42 may have a chordwise extent in the chordwise direction of the blade 20 which is wider than the width of the spar cap 50. This ensures the spar cap 50 is well protected from lightning strike by the surface protection layer 40.

As previously discussed, the surface protection layer 40 is an electrically conductive layer located at an outer surface 52 of the blade 20, however it will be seen from FIG. 5 that the blade 20 may include one or more of: a fleece layer 58, and a gelcoat and/or paint layer 59. For example, a fleece layer 58 and a gelcoat layer 59 may be located between the surface protection layer 40 and the outer surface 52 of the blade 20.

Both the first metal layer 41 and second metal layer 42 may extend substantially the entire spanwise length of the surface protection layer 40, as shown in FIG. 6, alternatively one of the first and second metal layers 41, 42 may extend only a portion of the spanwise length of the other of the metal layers 41, 42.

The first and/or second metal layers 41, 42 may be formed of any suitably electrically conductive metal, for example aluminium, copper, stainless steel, brass, or bronze. The first and/or second metal layers 41, 42 may be a metallic foil. A metallic foil may provide benefits in terms of being lightweight whilst being highly electrically conductive. Further weight savings may be achieved by forming the first and/or second metal layers 41, 42 as a metal mesh, solid foil, or an expanded metal foil. The first and/or second metal layers 41, 42 may be any suitably thin sheet-like conducting material. The sheet material for forming the first and/or second metal layers 41, 42 may have a thickness of less than 1 mm, optionally between 0.2 mm and 0.6 mm, and optionally between 0.25 mm and 0.5 mm or between 0.2 mm and 0.3 mm. The first and second metal layers 41, 42 may have the same thickness.

The first and second metal layers 41, 42 may be formed of the same material. For example, the first and second metal layers 41, 42 may both be aluminium layers. Alternatively, the first and second layers 41, 42 may be formed of different but complementary materials. For example, one of the layers 41, 42 may be formed of aluminium and the other layer 41, 42 may be formed of copper. Such a combination balances the light and inexpensive qualities of aluminium with the increased electrical conductivity of copper.

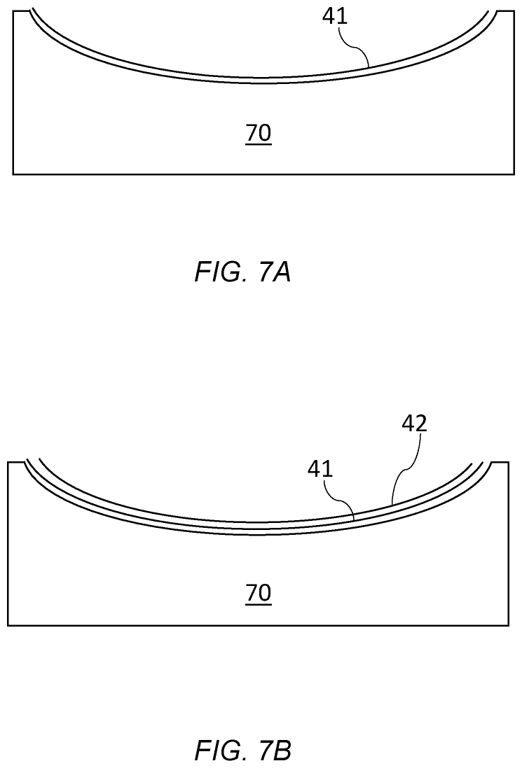

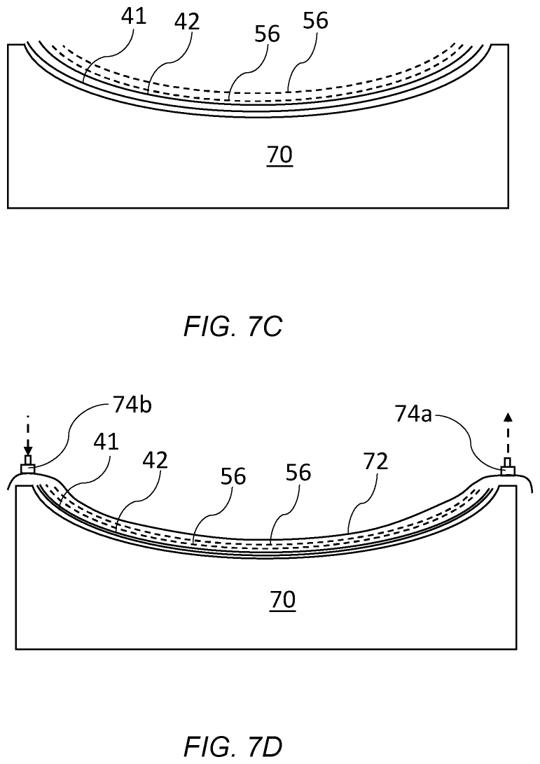

The wind turbine blade 20 may be manufactured in a blade mould 70, for example as shown in FIGS. 7A-7D. The outer layers, such as the fleece layer 58, may be positioned in the mould first. The first metal layer 41 of the surface protection layer 40 may then be laid into the mould, such as shown in FIG. 7A. The second metal layer 42 of the surface protection layer 40 may then be laid into the mould on top of the first metal layer 41, such as shown in FIG. 7B, so that the second metal layer 42 is stacked on the first metal layer 41 to form a multiple-thickness region. Alternatively, the second metal layer may be laid in the mould first with the first metal layer laid on top of the second metal layer.

One or more fibre layers 56 may be laid on top of the surface protection layer 40, such as shown in FIG. 7C. Further blade materials (not shown) such as the spar cap may then be laid on top of the fibre layers. The layers in the mould, including the surface protection layer 40 and fibre layers 56, may then be consolidated. This may involve forming a vacuum seal by placing a plastic film or sheet 72 over the mould 70 so as to cover the fibre layers 56 and surface protection layer 40, such as shown in FIG. 7D. A vacuum pressure may then be applied via a first valve 74a. Consolidating the layers helps to form the intimate electrical contact between the first metal layer 41 and second metal layer 42.

After consolidating the layers, a resin may be introduced into the fibre layers to form a composite. For example, the resin may be infused through the layers 40, 56 via a second valve 74b whilst still under the vacuum pressure. Alternatively, in some examples, the fibre layers 56 may be composite pre-preg layers (i.e. fibre layers pre-impregnated with resin) in which case infusion of a resin via the second valve 74b is not necessary. An outer surface of the blade 20 may then be formed by curing the layers, for example by applying heat and/or pressure to the assembled layers 40, 56.

During the cure process, the resin which has flowed between the fibre layers 56 cures so as to integrate the layers 40, 56 of the blade shell and form a substantially unitary outer blade shell. The intimate electrical contact between the first metal layer 41 and second metal layer 42 remains undisturbed.

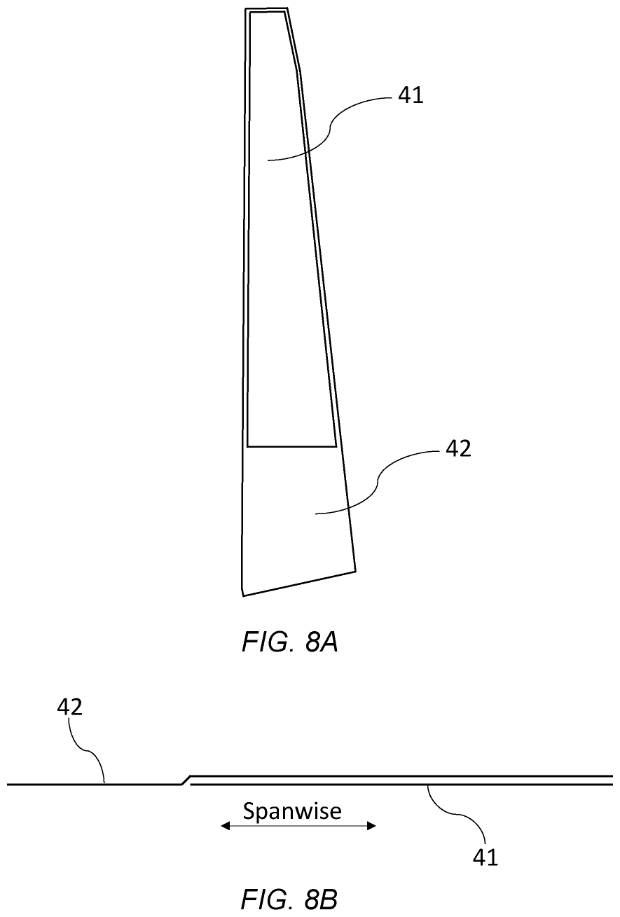

It will be understood that whilst the previous examples show the multiple-thickness region extending across substantially all of the first and second metal layers 41, 42, it will be understood that the multiple-thickness region may extend over only a portion of the first and/or second metal layers 41, 42. For example, FIGS. 8A and 8B show an example in which the multiple-thickness region extends across approximately 70% of the surface area of the second metal layer 42. The first metal layer 41 may extend across substantially all the chordwise width of the second metal layer 42, alternatively the first metal layer 41 may extend across only a portion of the chordwise width of the second metal layer 42. In some examples, the multiple-thickness region may extend across more or less of the surface area of the second metal layer 42 than shown in FIGS. 8A and 8B, for example at least 50%, at least 70%, or at least 90% of the surface area of the second metal layer 42.

The first metal layer 41 may be laid entirely within an outer perimeter of the second metal layer 42, or vice versa. Alternatively, the first metal layer 41 may extend beyond a perimeter of the second metal layer 42, or vice versa.

It will be understood that the multiple-thickness region is not merely an overlapping region but has a width of at least 200 mm and a length of at least 200 mm. In some examples, the multiple-thickness region may have a width of at least 1 m and/or a length of at least 1 m. The multiple-thickness region will be understood to be a continuous region in which the blade shell includes at least two metal layers 41, 42 stacked in the thickness direction over a significant extent of the blade.

In some examples, the first metal layer 41 and/or second metal layer 42 may comprise a plurality of metal layer portions 41a, 41b, 42a, 42b. The metal layer portions 41a, 41b, 42a, 42b may have overlapping edges 43. FIG. 9A shows an example in which the first metal layer 41 is formed of a first-first metal layer portion 41a and a second-first metal layer portion 41b. The metal layer portions 41a, 41b of the first metal layer 41 are shown to overlap in a spanwise direction, such that the overlapping edges 43 of the metal layer portions 41a, 41b extend in the spanwise direction, however it will be understood that the overlapping edges 43 may extend in the chordwise direction or at any angle to the spanwise direction of the wind turbine blade 20.

A second metal layer 42 may subsequently be stacked on the first metal layer 41. The second metal layer 42 may be formed of a plurality of second metal layer portions 42a, 42b. The second metal layer 42 may comprise a first-second metal layer portion 42a and a second-second metal layer portion 42b. The second metal layer portions 42a, 42b may have overlapping edges 43. The overlapping edges 43 of the first metal layer portions 41a, 41b and the overlapping edges 43 of the second metal layer portions 42a, 42b may be offset from one another to prevent a localised build-up of (e.g.) four or more layers in a region of the wind turbine blade 20. Alternatively, a gap may exist between second metal layer portions 42a, 42b where an overlapping edge 43 of the first metal layer portions 41a, 41b exists, as shown in FIG. 9B, or vice-versa.

The various permutations and arrangements of the first and second metal layers 41, 42 may provide for a bespoke surface protection layer 40 for a particular wind turbine blade 20, and for a particular environment or application of that wind turbine blade 20. For example, a plurality of wind turbine blades 20 may be provided. The wind turbine blades 20 may each have a substantially identical shape and size (for example, as shown in FIG. 1), however the arrangement of the first and second metal layers 41, 42 of one of the plurality of wind turbine blades 20 may be designed to be different to an arrangement of the first and second metal layers 41, 42 of another one of the plurality of wind turbine blades.

As previously mentioned, the down conductor cable 38 and surface protection layer 40 may be connected by one of more connectors. The connectors may include an electrically conductive pin 61 that extends through the multiple-thickness region and connects the first and second metal layers 41, 42 of the surface protection layer to the remainder of the lightning protection system.

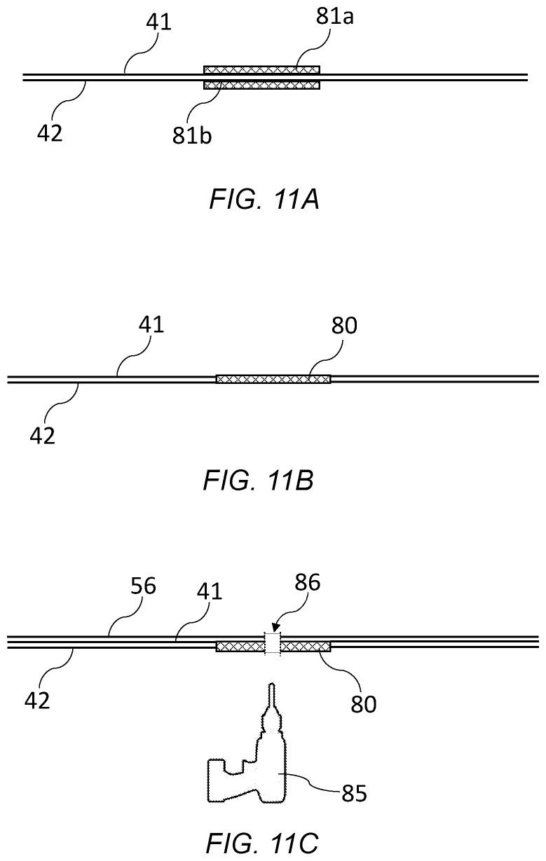

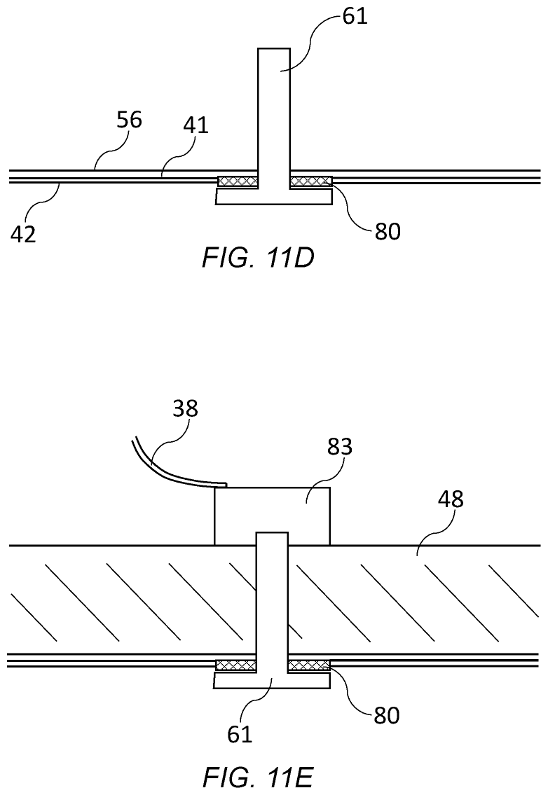

In the vicinity of the conductive pin 61, the first and second metal layers 41, 42 may be pre-attached together, prior to being laid in the mould 70. For example, in order to promote a good electrical contact between the metal layers 41, 42 and the connectors (particularly the electrically conductive pins 61), the metal layers 41, 42 may include reinforced zones. FIGS. 11A-11E show an example of the formation of a reinforced zone, in which the connector comprises a disc 80 extending through and connecting the first and second metal layers 41, 42 although it will be appreciated that the reinforced zone may comprise any suitably conductive element.

In such cases where the first and second metal layers 41, 42 overlap a location of an electrically conductive pin 61, the first and second metal layers 41, 42 may be pre-attached together and laid up in the blade mould concurrently. The handleability of multiple pre-attached metal layers 41, 42 may be decreased compared to a single metal layer 41, 42, as one or both layers 41, 42 may warp or shear or otherwise move out of alignment with the other metal layer 41, 42, and this can make manufacturing more difficult. The handleability may decrease further when the first and second metal layers 41, 42 are connected at more than one discrete location. The pre-attached first and second metal layers 41, 42 may therefore be cut so that only a single electrically conductive pin 61 location coincides with a particular discrete portion of the surface protection layer being laid in the blade mould.

In this case, the wind turbine blade 20 may include a first electrically conductive pin 61a and a second electrically conductive pin 61b that are adjacent to one another. In this context, adjacent may mean the first and second electrically conductive pins 61a, 61b are within 5%, 4%, 3%, 2% or 1% of the total blade length from one another. The portions of the metal layers 41, 42 of the first electrically conductive pin 61a may be adjacent to the portions of the metal layers 41, 42 of the second electrically conductive pin 61b.

Alternatively, or in addition, the first and second metal layers 41, 42 may be cut such that the size of a discrete portion of the metal layer 41, 42 through which an electrically conductive pin 61, 61a, 61b extends is minimised to a size more manageable for handling.

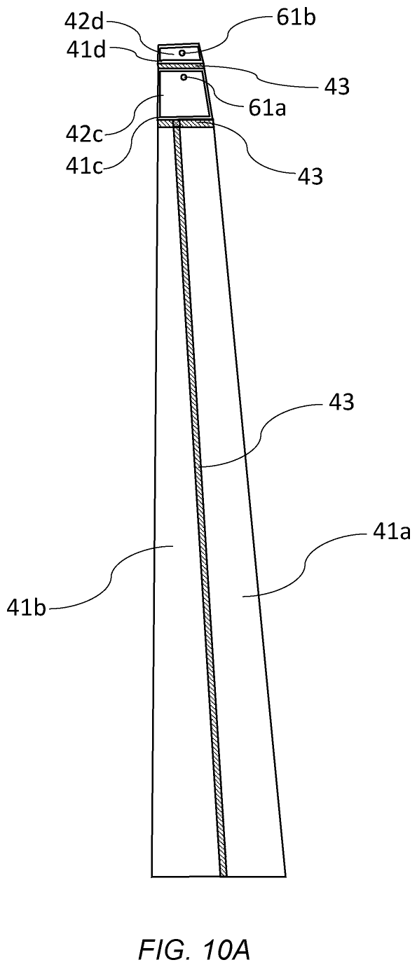

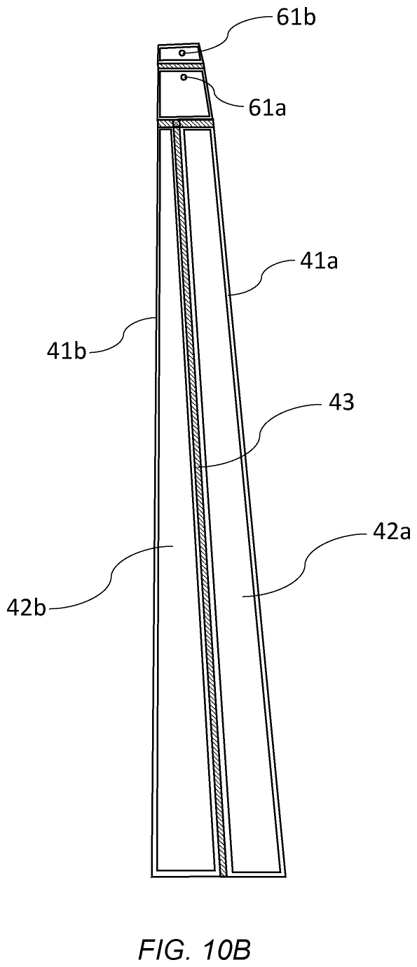

FIGS. 10A and 10B show part of a lightning protection system in which the first metal layer 41 is split into four first metal layer portions 41a, 41b, 41c, 41d and the second metal layer 42 is split into four corresponding second metal layer portions 42a, 42b, 42c, 42d (note that second metal layer portions 42a, 42b are not shown in FIG. 10A, as will be explained below), and in which a first electrically conductive pin 61a extends through one of the first metal layer portions 41c and second metal portions 42c but not through any of the other metal layer portions 41a, 41b, 41d, 42a, 42b, 42d. Similarly, a second electrically conductive pin 61b extends through one of the first metal layer portions 41d and second metal portions 42d but not through any of the other metal layer portions 41a, 41b, 41c, 42a, 42b, 42c. This helps to improve the handleability of the metal layer portions 41a-d, 42a-d, as the first metal layer portions 41a-d and second metal layer portions 42a-d may be connected to one another at a single discrete location.

Accordingly, portions of the second metal layer 42 (e.g. portions 42c, 42d in FIG. 10A) may be laid in the mould 70 at the same time as the first metal layer 41. The remaining portions of the second metal layer 42 (e.g. portions 42a, 42b in FIG. 10B) may subsequently be added to the mould 70 in a separate step, for example as shown in FIG. 10B.

As previously discussed, the first and second metal layers 41, 42 may be joined by a metal disc 80. The metal disc 80 may extend through the first and second metal layers 41, 42 so as to fixedly connect the metal layers 41, 42 together. The metal disc 80 is for connection to an electrical component of the lightning protection system, for example the metal disc 80 may function as a platform for an electrically conductive pin 61 to extend through. The electrical component may be a down conductor cable 38 of the lightning protection system.

The metal disc 80 may be formed from one or more metal disc constituents. The metal disc constituents may be a pair of metal disc portions 81a, 81b, for example as shown in FIG. 11A. The metal disc portions 81a, 81b may be laid on either side of the first and second metal layers 41, 42, such that the first and second metal layers 41, 42 are sandwiched between the first and second metal disc portions 81a, 81b.

The metal disc portions 81a, 81b may subsequently be consolidated to form a single metal disc 80 that extends through the first and second metal layers 41, 42. FIG. 11B shows an example of a metal disc 80 extending across the first and second metal layers 41, 42.

In some examples, the metal disc 80 may be formed by heating the first and second metal disc portions 81a, 81b together. Alternatively, the metal disc 80 (such as shown in FIG. 11B) may be cast from molten metal to form a metal disc 80 that extends through the first and second metal layers 41, 42.

One or more fibre layers 56 may be laid on the metal disc 80, as shown in FIG. 11C. A drill 85 or other device may form a hole 86 through the metal disc 80 and fibre layers 56 so as to provide a through-hole for inserting an electrically conductive pin 61, as shown in FIG. 11D. By forming the through hole, the disc 80 becomes an annulus.

The electrically conductive pin 61 may extend through the hole 86 so as to electrically connect the first and second metal layers 41, 42 of the surface protection layer to the rest of the lightning protection system. For example, FIG. 11E shows an electrically conductive pin 61 extending through the metal disc 80 to a receptor block 83, and in doing so extending through the first and second metal layers 41, 42, a plurality of fibre layers 56, and through a further structural component 48 (e.g. including fibre layers, core materials such as foam, and similar, as will be appreciated by the person skilled in the art). The receptor block 83 may be bonded to the inner surface of the blade 20, for example the receptor block 83 may be bonded to the structural component 48. The receptor block 83 is electrically conductive, and may be connected to a down conductor cable 38 that extends through the blade 20. In this way, the first and second metal layers 41, 42 may form part of the lightning protection system of the wind turbine blade 20.

It will be understood that the multiple-thickness region may comprise only two metal layers 41, 42, such that any regions with a triple-thickness of the metal layers 41, 42 are discrete overlapping regions having a size of less than 200 mm. Alternatively, it may be desirable that the blade shell has one or more multiple-thickness regions having three of more metal layers.

Although the invention has been described above with reference to one or more preferred embodiments, it will be appreciated that various changes or modifications may be made without departing from the scope of the invention as defined in the appended claims.

1. A wind turbine blade having a blade shell with a lightning protection system;
the lightning protection system comprising:
a first metal layer at an outer surface of the blade shell; and
a second metal layer at the outer surface of the blade shell and stacked on the first metal layer to form intimate electrical contact with the first metal layer at a multiple-thickness region; and
wherein the multiple-thickness region has a width of at least 200 mm and a length of at least 200 mm.

2. A wind turbine blade having a blade shell with a lightning protection system;
the lightning protection system comprising:
a first metal layer at an outer surface of the blade shell; and
a second metal layer at the outer surface of the blade shell and stacked on the first metal layer to form intimate electrical contact with the first metal layer at a multiple-thickness region; and
an electrical component,
wherein the first and second metal layers are electrically connected to the electrical component by an electrically conductive pin that extends through the multiple-thickness region.

3. The wind turbine blade of claim 2, wherein the multiple-thickness region has a width of at least 200 mm and a length of at least 200 mm.

4. The wind turbine blade of claim 1, wherein the multiple-thickness region has a width of at least 1 m and a length of at least 1 m.

5. The wind turbine blade of claim 1, wherein the multiple-thickness region extends across at least 50% of a surface area of the second metal layer.

6. The wind turbine blade of claim 2, wherein the electrical component is a down conductor of the lightning protection system.

7. The wind turbine blade of claim 1, wherein the first metal layer and the second metal layer are formed of the same material and/or have the same thickness.

8. The wind turbine blade of claim 1, wherein the first metal layer and the second metal layer are formed of different materials, preferably wherein one of the first and second metal layers is formed of aluminium and the other of the first and second metal layers is formed of copper.

9. The wind turbine blade of claim 1, wherein the first metal layer comprises a plurality of first metal layer portions with overlapping edges and/or the second metal layer comprises a plurality of second metal layer portions with overlapping edges.

10. The wind turbine blade of claim 9, wherein the overlapping edges have an overlap width of less than 200 mm.

11. The wind turbine blade of claim 9, wherein the overlapping edges of the first or second metal layer are offset from any overlapping edges of the other of the first and second metal layer.

12. The wind turbine blade of claim 1, wherein the first and second metal layers are joined by a metal disc that extends through the first and second metal layers, wherein the metal disc is for connection to an electrical component of the lightning protection system.

13. A plurality of wind turbine blades according to claim 1, wherein the plurality of wind turbine blades have a substantially identical shape and size, and wherein an arrangement of the first and second metal layers of one of the plurality of wind turbine blades is designed to be different to an arrangement of the first and second metal layers of another one of the plurality of wind turbine blades.

14. A method of manufacturing a wind turbine blade having a blade shell, comprising:
laying a first metal layer of a lightning protection system of the blade shell into a blade mould;
laying a second metal layer of the lightning protection system into the blade mould so that the second metal layer is stacked on the first metal layer to form a multiple-thickness region having a width of at least 200 mm and a length of at least 200 mm.

15. A method of manufacturing a wind turbine blade having a blade shell, comprising:
laying a first metal layer of a lightning protection system of the blade shell into a blade mould;
laying a second metal layer of the lightning protection system into the blade mould so that the second metal layer is stacked on the first metal layer to form a multiple-thickness region; and
extending an electrically conductive pin through the multiple-thickness region to electrically connect the first and second metal layers to an electrical component of the lightning protection system.

16. The method of manufacturing a wind turbine blade of claim 14, further comprising:
laying fibre layers of the blade shell in the blade mould; consolidating the fibre layers and the first and second metal layers in the blade mould to form intimate electrical contact between the first and second metal layers, prior to integration of the blade shell with a resin.

17. The method of manufacturing a wind turbine blade of claim 14, further comprising, prior to laying the first and second metal layers in the blade mould:
providing one or more metal disc constituents; and
heating the one or more metal disc constituents to form a metal disc that extends through the first and second metal layers.
